(19) United States
(12) Patent Application Publication
(10) Pub. No.: US 2024/0376405 A1
(43) Pub. Date: Nov. 14, 2024

(54) Color-Protecting Detergents

(71) Applicant: Henkel AG & Co. KGaA, Duesseldorf (DE)

(72) Inventors: Kira Neubauer, Wuppertal (DE); Christian Kropf, Hilden (DE); Elke Schaefer, Hilden (DE); Seema Agarwal, Marburg (DE); Jonathan Millican, Mainz (DE)

(21) Appl. No.: 18/781,662

(22) Filed: Jul. 23, 2024

Related U.S. Application Data
(63) Continuation of application No. PCT/EP2022/085170, filed on Dec. 9, 2022.

(30) Foreign Application Priority Data
Jan. 26, 2022 (DE) 102022200881.2
Dec. 9, 2022 (WO) PCT/EP2022/085170

(51) Int. Cl. C11D 3/37; C11D 3/00

(52) U.S. Cl. CPC C11D 3/3776; C11D 3/0021; C11D 2111/12

(57) ABSTRACT

Copolymers obtained by radical polymerization of cyclic ketene acetals with vinylimidazole monomers and/or vinylpyrrolidone monomers, are included in a surfactant-containing aqueous detergent solution in order to prevent the transfer of textile dyes from colored textiles to uncolored or other colored textiles when they are washed together in the detergent solution.

### FIELD OF THE INVENTION

The present invention relates to the use of specific copolymers made of ketene derivatives and monoethylenically unsaturated comonomers as dye-transfer-inhibiting active ingredients when washing textiles and to detergents which contain such active ingredients.

### BACKGROUND OF THE INVENTION

In addition to the ingredients such as surfactants and builder materials that are essential to the washing process, detergents generally contain further constituents which can be referred to collectively by the term washing auxiliaries and comprise the very different active ingredient groups such as foam regulators, graying inhibitors, bleaching agents, bleach activators and enzymes. Such auxiliaries also include substances which are intended to prevent colored textiles from causing a changed color impression after washing. This change in color impression of washed, i.e., cleaner, textiles can be based on the fact that dye proportions are removed from the textile by the washing process (“fading”) but it is also possible that dyes separated from textiles of other colors can be deposited on the textile (“discoloration”). The discoloration aspect can also play a role in uncolored items of laundry if they are washed together with colored items of laundry. In order to avoid these undesired side effects of removing dirt from textiles by treatment with usually surfactant-containing aqueous systems, detergents contain, in particular if they are provided as “colored detergents” for washing colored textiles, active ingredients which prevent the separation of dyes from the textile or which are at least intended to prevent separated dyes located in the washing liquor from being deposited on textiles. Many of the polymers commonly used have such a high affinity for dyes that they increasingly draw them from the dyed fiber, which results in increased color loss.

Known dye transfer inhibitors are, for example, polymers of vinylpyrrolidone, vinylimidazole, vinylpyridine N-oxide and copolymers thereof. The dye-transfer-inhibiting properties of specific triazine derivatives are known from international patent applications WO 2008/110469 A1 and WO 2007/019981 A1.

Surprisingly, it has been found that copolymers made of cyclic ketene acetals with acrylic or vinyl monomers in the washing process have a positive effect on the dye transfer and prevent coloration of uncolored textiles.

From V. Delplace, E. Guegain, S. Harrisson, D. Gigmes, Y. Guillaneuf, J. Nicolas, Chern. Commun., 2015, 51, 12847-12850, the reaction of 2-methylene-4-phenyl-1,3-dioxolane with methacrylic acid esters is known. The patent application WO 2012/120138 A1 discloses polymers crosslinked by bio-resorbable crosslinkers and made of α,β-unsaturated carboxylic acid esters or amides and cyclic ketene acetals. Copolymers of vinylpyrrolidone and 2-methylene-1,3-dioxepane are known from patent U.S. Pat. No. 5,912,312. The patent applications DE 10 2008 018 905 A1 and DE 10 2008 028 146 A1 disclose copolymers of cyclic ketene acetals and up to two different methacrylic acid derivatives.

### BRIEF SUMMARY OF THE INVENTION

The invention relates to the use of copolymers obtained by radical polymerization of cyclic ketene acetals with vinylimidazole monomers and/or vinylpyrrolidone monomers, in order to prevent the transfer of textile dyes from colored textiles to uncolored or other colored textiles when they are washed together, in particular, in surfactant-containing aqueous solutions.

In the case of radical polymerization of cyclic ketene acetals, the acetal ring is opened, so that ester functionalities arise which lead to an improvement in biodegradability in the resulting polymer. This improved biodegradability is to be regarded as a further advantage of the invention.

### DETAILED DESCRIPTION OF THE INVENTION

The copolymers used according to the invention are preferably composed of 5 mol % to 50 mol %, in particular 15 mol % to 35 mol %, of at least one cyclic ketene acetal monomer and 50 mol % to 95 mol %, in particular 65 mol % to 85 mol %, vinyl monomers or mixtures thereof with acrylic monomers, wherein the vinyl monomers consist at least partially, preferably completely, of vinylimidazole monomers and/or vinylpyrrolidone monomers. The copolymers contain, apart from fractions coming from radical initiators or radical terminators, preferably no constituents originating from other monomers than said monomers. The copolymers are preferably present statistically, but can also contain a gradient or be constructed as block copolymers.

The ketene acetal is preferably selected from 2-methylene-1,3-dioxolane, 2-methylene-1,3-dioxane, 2-methylene-1,3-dioxepane, which may be substituted in the acetal ring, for example 4,5,-di-C₁₋₁₂-alkyl-2-methylene-1,3-dioxolane, 4-C₁₋₁₂alkyl-2-methylene-1,3-dioxolane, 5-C₁₋₁₂-alkyl-2-methylene-1,3-dioxepane, 5,6-di-C₁₋₁₂-alkyl-2-methylene-1,3-dioxepane, 4-C₁₋₁₂-alkyl-2-methylene-1,3-dioxane, 4,6-di-C₁₋₁₂-alkyl-2-methylene-1,3-dioxolane and 5,6-benzo-2-methylene-1,3-dioxepane, 4-phenyl-2-methylene-1,3-dioxolane, 4,5-diphenyl-2-methylene-1,3-dioxolane, 4-phenyl-2-methylene-1,3-dioxane, 4,6-diphenyl-2-methylene-1,3-dioxolane, 4-phenyl-2-methylene-1,3-dioxepane, 4,7-diphenyl-2-methylene-1,3-dioxepane and mixtures thereof.

The comonomer polymerizable with the ketene acetal is selected from vinylimidazole, vinylpyrrolidone, mixtures thereof, and mixtures of vinylimidazole and/or vinylpyrrolidone with preferably acrylic acid esters, acrylic acid amides, methacrylic acid esters, methacrylic acid amides, and mixtures thereof, wherein, as the alcohol component of the esters and the amine component of the amides, in particular 1-(3-hydroxypropyl)-1H-imidazole, 1-(3-hydroxypropyl) pyrrolidin-2-one, 1-(3-aminopropyl) imidazole, 1-(3-aminopropyl)-2-pyrrolidone or N,N-dimethylpropane-1,3-diamine and mixtures thereof are suitable.

The monomers mentioned can be polymerized according to the guidelines known from the literature as cited above or based on them.

In both aspects addressed above, the active ingredients that can thus be obtained make a contribution to the color consistency, i.e., they reduce both the discoloration and the fading, although the effect of preventing coloration, in particular when washing white textiles, is most marked. The invention therefore also relates to the use of active ingredients that can be obtained in this way to prevent the color impression of colored textiles changing, preferably those consisting of or containing cotton, when washed in, in particular surfactant-containing, aqueous solutions. The change in color impression is not to be understood as meaning the difference between the soiled and clean textile, but the difference between each clean textile before and after the washing process. The invention therefore also relates to a detergent containing surfactant and other conventional ingredients of detergents and a copolymer as defined above in the dye-transfer-inhibiting amount. A dye-transfer-inhibiting amount should be understood to mean an amount which significantly reduces the transfer of dyes from colored textiles to uncolored textiles or textiles of other colors when washed together, in comparison with otherwise identical conditions in the absence of the active ingredient. The aforementioned dye-transfer-inhibiting active ingredients are preferably used in detergents in amounts of from 0.01 wt. % to 5 wt. %, in particular from 0.05 wt. % to 0.5 wt. %.

The invention also relates to a method for washing white or colored textiles in surfactant-containing aqueous solutions in the presence of textiles of other colors, the method being characterized in that a surfactant-containing aqueous liquor is used which contains a copolymer as defined above. In such a method, it is possible to wash white or uncolored textiles together with the colored textile without the white or uncolored textile becoming colored. Preferably, 0.0003 g/l to 0.16 g/l, in particular 0.0015 g/l to 0.015 g/l of the copolymer defined above is used in the aqueous liquor.

In addition to the aforementioned dye transfer inhibitor, a detergent can contain conventional ingredients compatible with this constituent. For instance, the detergent can additionally contain another dye transfer inhibitor, preferably in amounts of 0.1 wt. % to 2 wt. %, in particular 0.2 wt. % to 1 wt. %, which, in a preferred embodiment, is selected from the polymers of vinylpyrrolidone, vinylimidazole, vinylpyridine-N-oxide, or the copolymers thereof. It is possible to use polyvinylpyrrolidones having molecular weights of from 15,000 to 50,000 g/mol as well as polyvinylpyrrolidones having higher molecular weights of, for example, up to more than 1,000,000, in particular from 1,500,000 g/mol to 4,000,000 g/mol, N-vinylimidazole/N-vinylpyrrolidone copolymers, polyvinyloxazolidones, copolymers based on vinyl monomers and carboxylic acid amides, pyrrolidone-group-containing polyesters and polyamides, grafted polyamidoamines and polyethyleneimines, polyamine-N-oxide polymers, polyvinyl alcohols, and copolymers based on acrylamido alkenyl sulfonic acids can be used. However, it is also possible to use enzymatic systems comprising a peroxidase and hydrogen peroxide or a substance which produces hydrogen peroxide in water. The addition of a mediator compound for the peroxidase, for example an acetosyringone, a phenol derivative or a phenotiazine or phenoxazine, is preferred in this case, it also being possible to additionally use above-mentioned polymeric dye transfer inhibitor active ingredients. Polyvinylpyrrolidone preferably has an average (weight average) molar mass in the range from 10,000 to 60,000, in particular in the range from 25,000 to 50,000, for use in agents according to the invention. Of the copolymers, those consisting of vinylpyrrolidone and vinylimidazole in a molar ratio of 5:1 to 1:1 with an average (weight average) molar mass in the range of from 5,000 g/mol to 50,000 g/mol, in particular 10,000 g/mol to 20,000 g/mol, are preferred.

Detergents which may be in the form of in particular powdered solids, in further-compacted particulate form, homogeneous solutions, or suspensions, may in principle contain, in addition to the active ingredient used according to the invention, any known ingredients that are conventional in such agents of this kind. The agents according to the invention may, in particular, comprise builder substances, surface-active surfactants, bleaching agents based on organic and/or inorganic peroxygen compounds, bleach activators, water-miscible organic solvents, enzymes, sequestering agents, electrolytes, pH regulators, and further auxiliaries, such as optical brighteners, graying inhibitors and foam regulators, as well as dyes and fragrances.

The agents can contain one or more surfactants, with anionic surfactants, non-ionic surfactants and mixtures thereof being particularly suitable, but cationic, zwitterionic and/or amphoteric surfactants also being suitable.

Suitable non-ionic surfactants are in particular alkyl glycosides and ethoxylation and/or propoxylation products of alkyl glycosides or linear or branched alcohols each having 12 to 18 C atoms in the alkyl portion and 3 to 20, preferably 4 to 10, alkyl ether groups. Corresponding ethoxylation and/or propoxylation products of N-alkyl amines, vicinal diols, fatty acid esters and fatty acid amides which, with regard to the alkyl portion, correspond to the long-chain alcohol derivatives mentioned, and of alkyl phenols having 5 to 12 C atoms in the alkyl group can also be used.

Non-ionic surfactants that are preferably used are alkoxylated, advantageously ethoxylated, in particular primary alcohols having preferably 8 to 18 C atoms and, on average, 1 to 12 mols of ethylene oxide (EO) per mol of alcohol, in which the alcohol functional group can be linear or preferably methyl-branched in position 2, or can contain linear and methyl-branched functional groups in admixture, as are usually present in oxo alcohol functional groups. However, alcohol ethoxylates having linear functional groups of alcohols of native origin having 12 to 18 C atoms, for example of coconut, palm, tallow fatty or oleyl alcohol, and an average of 2 to 8 EO per mol of alcohol, are particularly preferred. Preferred ethoxylated alcohols include, for example, C₁₂-C₁₄ alcohols having 3 EO or 4 EO, C₉-C₁₁ alcohols having 7 EO, C₁₃-C₁₅ alcohols having 3 EO, 5 EO, 7 EO or 8 EO, C₁₂-C₁₈ alcohols having 3 EO, 5 EO or 7 EO and mixtures thereof, such as mixtures of C₁₂-C₁₄ alcohol having 3 EO and C₁₂-C₁₈ alcohol having 7 EO. The degrees of ethoxylation specified represent statistical averages that can correspond to an integer or a fractional number for a specific product. Preferred alcohol ethoxylates have a narrowed homolog distribution (narrow range ethoxylates, NRE). In addition to these non-ionic surfactants, fatty alcohols having more than 12 EO can also be used. Examples of these are (tallow) fatty alcohols having 14 EO, 16 EO, 20 EO, 25 EO, 30 EO and 40 EO. It is conventional to use extremely low-foaming compounds in particular in agents for use in machine processes. These preferably include C12-C18-alkyl polyethylene glycol polypropylene glycol ethers each having up to 8 mol of ethylene oxide and propylene oxide units in the molecule. However, other known low-foam non-ionic surfactants can also be used, such as C₁₂-C₁₈ alkyl polyethylene glycol polybutylene glycol ethers each having up to 8 mol of ethylene oxide and butylene oxide units in the molecule and end-capped alkylpolyalkylene glycol mixed ethers. The hydroxyl-group-containing alkoxylated alcohols, known as hydroxy mixed ethers, are also particularly preferred. Non-ionic surfactants also include alkyl glycosides of general formula RO(G)ₓ be used, in which R means a primary straight-chain or methyl-branched, aliphatic functional group, in particular an aliphatic functional group that is methyl-branched in the 2nd position, having 8 to 22, preferably 12 to 18, C atoms, and G represents a glycose unit having 5 or 6 C atoms, preferably glucose. The degree of oligomerization x, which indicates the distribution of monoglycosides and oligoglycosides, is any number—which can also assume fractional values as a variable to be analytically determined—between 1 and 10; x is preferably between 1.2 and 1.4. Likewise suitable are polyhydroxy fatty acid amides of formula IV, in which R¹CO represents an aliphatic acyl group having 6 to 22 carbon atoms, R² represents hydrogen, an alkyl or hydroxy alkyl group having 1 to 4 carbon atoms and [Z] represents a linear or branched polyhydroxy alkyl group having 3 to 10 carbon atoms and 3 to 10 hydroxyl groups:

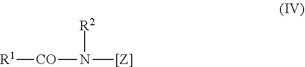

Polyhydroxy fatty acid amides are preferably derived from reducing sugars, in particular glucose, having 5 or 6 carbon atoms. The group of polyhydroxy fatty acid amides also includes compounds of formula (IV),

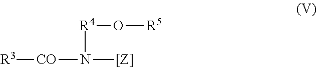

in which R³ represents a linear or branched alkyl or alkenyl group having 7 to 12 carbon atoms, R⁴ represents a linear, branched or cyclic alkyl group or an aryl group having 2 to 8 carbon atoms, and R⁵ represents a linear, branched or cyclic alkyl group or an aryl group or an oxy alkyl group having 1 to 8 carbon atoms, wherein C₁-C₄ alkyl or phenyl groups are preferred, and [Z] represents a linear polyhydroxy alkyl group, the alkyl chain of which is substituted with at least two hydroxyl groups, or alkoxylated, preferably ethoxylated or propoxylated derivatives of this functional group. [Z] is also preferably obtained by reductive amination of a sugar, for example glucose, fructose, maltose, lactose, galactose, mannose or xylose. The N-alkoxy- or N-aryloxy-substituted compounds can be converted into the desired polyhydroxy fatty acid amides by reaction with fatty acid methyl esters in the presence of an alkoxide as a catalyst. Another class of non-ionic surfactants that are preferably used, which are used either as the sole non-ionic surfactant or in combination with other non-ionic surfactants, in particular together with alkoxylated fatty alcohols and/or alkyl glycosides, is alkoxylated, preferably ethoxylated or ethoxylated and propoxylated fatty acid alkyl esters, preferably having 1 to 4 carbon atoms in the alkyl chain, in particular fatty acid methyl esters. Non-ionic surfactants of the aminoxide type, for example N-cocoalkyl-N,N-dimethylamine oxide and N-tallow-alkyl-N,N-dihydroxyethylamine oxide, and of the fatty acid alkanolamides may also be suitable. The quantity of these non-ionic surfactants is preferably no more than that of the ethoxylated fatty alcohols, in particular no more than half thereof. Surfactants known as gemini surfactants can also be considered. These are generally understood to mean those compounds which have two hydrophilic groups per molecule. These groups are generally separated from one another by a “spacer.” This spacer is generally a carbon chain that should be long enough that the hydrophilic groups are sufficiently spaced apart so that they can act independently of one another. Such surfactants are generally characterized by an unusually low critical micelle concentration and the ability to greatly reduce the surface tension of the water. In exceptional cases, the expression gemini surfactants is understood to mean not only “dimeric” but also “trimeric” surfactants. Suitable gemini surfactants are, for example, sulfated hydroxy mixed ethers or dimer alcohol bis- and trimer alcohol tris sulfates and ether sulfates. End-capped dimeric and trimeric mixed ethers are characterized in particular by their bi- and multifunctionality. The aforementioned end-capped surfactants thus have good wetting properties and are low-foaming, which means that they are particularly suitable for use in machine washing or cleaning processes. However, gemini polyhydroxy fatty acid amides or poly-polyhydroxy fatty acid amides can also be used.

Suitable anionic surfactants are, in particular, soaps and those which contain sulfate or sulfonate groups. Preferably, C₉-C₁₃ alkylbenzene sulfonates, olefin sulfonates, i.e., mixtures of alkene and hydroxyalkane sulfonates, and disulfonates, as obtained, for example, from C₁₂-C₁₈ monoolefins having a terminal or internal double bond by means of sulfonation with gaseous sulfur trioxide and subsequent alkaline or acid hydrolysis of the sulfonation products, are possible as surfactants of the sulfonate type. Alkane sulfonates obtained from C₁₂-C₁₈ alkanes, for example by means of sulfochlorination or sulfoxidation with subsequent hydrolysis or neutralization, are also suitable. The esters of α-sulfo fatty acids (ester sulfonates), for example the α-sulfonated methyl esters of hydrogenated coconut, palm kernel or tallow fatty acids, which are produced by α-sulfonation of the methyl esters of fatty acids of vegetable and/or animal origin having 8 to 20 C atoms in the fatty acid molecule and subsequent neutralization so as to produce water-soluble mono-salts, are also considered to be suitable. Preferably, these are the α-sulfonated esters of hydrogenated coconut, palm, palm kernel or tallow fatty acids, it also being possible for sulfonation products of unsaturated fatty acids, for example oleic acid, to be present in small amounts, preferably in amounts of no more than approximately 2 to 3 wt. %. Particularly preferred are α-sulfo fatty acid alkyl esters which have an alkyl chain having no more than 4 C atoms in the ester group, for example methyl ester, ethyl ester, propyl ester, and butyl ester. Particularly advantageously, the methyl esters of α-sulfo fatty acids (MES), but also the saponified di-salts thereof, are used. Other suitable anionic surfactants are sulfonated fatty acid glycerol esters, which constitute monoesters, diesters and triesters and the mixtures thereof, as they are obtained during production by means of esterification by a monoglycerol with 1 to 3 mol of fatty acid or during the transesterification of triglycerides with 0.3 to 2 mol of glycerol. The alkali salts and in particular the sodium salts of the sulfuric acid half-esters of C₁₂-C₁₈ fatty alcohols, for example from coconut fatty alcohol, tallow fatty alcohol, lauryl alcohol, myristyl alcohol, cetyl alcohol or stearyl alcohol, or of C₁₀-C₂₀ oxo alcohols and the half-esters of secondary alcohols having this chain length, are preferred as alk (en) yl sulfates. Alk (en) yl sulfates of the mentioned chain length that contain a synthetic straight-chain alkyl functional group prepared on a petrochemical basis and have a degradation behavior similar to that of the adequate compounds based on fat chemical raw materials are also preferred. From a washing perspective, C₁₂-C₁₆ alkyl sulfates, C₁₂-C₁₅ alkyl sulfates and C₁₄-C₁₅ alkyl sulfates are particularly preferred. The sulfuric acid monoesters of straight-chain or branched C₇-C₂₁ alcohols ethoxylated with 1 to 6 mol ethylene oxide, such as 2-methyl-branched C₉-C₁₁ alcohols having, on average, 3.5 mol ethylene oxide (EO) or C₁₂-C₁₈ fatty alcohols having 1 to 4 EO, are also suitable. Preferred anionic surfactants also include the salts of alkyl sulfosuccinic acid, which are also referred to as sulfosuccinates or as sulfosuccinic acid esters and which represent monoesters and/or diesters of sulfosuccinic acid with alcohols, preferably fatty alcohols, and in particular ethoxylated fatty alcohols. Preferred sulfosuccinates contain C₈-C₁₈ fatty alcohol groups or mixtures thereof. Particularly preferred sulfosuccinates contain a fatty alcohol residue which is derived from ethoxylated fatty alcohols, which in themselves represent nonionic surfactants. Among these, in turn, sulfosuccinates, including fatty alcohol groups that derive from ethoxylated fatty alcohols exhibiting a restricted distribution of homologs, are particularly preferred. Likewise, it is also possible to use alk (en) yl succinic acid having preferably 8 to 18 carbon atoms in the alk (en) yl chain, or the salts thereof. Fatty acid derivatives of amino acids, for example of N-methyltaurine (taurides) and/or of N-methylglycine (sarcosides), are also considered as further anionic surfactants. The sarcosides or sarcosinates, and in this case especially sarcosinates of higher and optionally mono- or polyunsaturated fatty acids such as oleyl sarcosinate, are particularly preferred. Further anionic surfactants that can also be used are in particular soaps. In particular saturated fatty acid soaps are suitable, such as the salts of lauric acid, myristic acid, palmitic acid, stearic acid, hydrogenated erucic acid and behenic acid, and in particular soap mixtures derived from natural fatty acids, such as coconut fatty acids, palm kernel fatty acids or tallow fatty acids. The known alkenylsuccinic acid salts can also be used together with these soaps or as substitutes for soaps.

The anionic surfactants, including the soaps, can be present in the form of the sodium, potassium or ammonium salts thereof, or as soluble salts of organic bases, such as mono-, di- or triethanolamine. The anionic surfactants are preferably present in the form of the sodium or potassium salts thereof, in particular in the form of the sodium salts. Surfactants are contained in detergents in proportions of normally 1 wt. % to 50 wt. %, in particular from 5 wt. % to 30 wt. %.

A detergent preferably contains at least one water-soluble and/or water-insoluble, organic and/or inorganic builder. The water-soluble organic builder substances include polycarboxylic acids, in particular citric acid and saccharic acids; monomer and polymer aminopolycarboxylic acids, in particular methylglycinediacetic acid, nitrilotriacetic acid, ethylenediaminetetraacetic acid and polyaspartic acid; polyphosphonic acids, in particular aminotris (methylene phosphonic acid), ethylenediaminetetrakis (methylenephosphonic acid) and 1-hydroxyethane-1,1-diphosphonic acid; polymer hydroxy compounds such as dextrin; and polymer (poly) carboxylic acids, in particular the polycarboxylates which can be obtained by oxidation of polysaccharides or dextrins; polymer acrylic acids, methacrylic acids, maleic acids and mixed polymers from these, which may also contain small proportions of polymerizable substances without carboxylic acid functionality in polymerized form. The relative molecular mass of the homopolymers of unsaturated carboxylic acids is generally between 3,000 g/mol and 200,000 g/mol, that of the copolymers between 2,000 g/mol and 200,000 g/mol, preferably 30,000 g/mol to 120,000 g/mol, in each case based on free acid. A particularly preferred acrylic acid-maleic acid copolymer has a relative molecular mass of 30,000 g/mol to 100,000 g/mol. Commercial products are, for example, Sokalan® CP 5, CP 10 and PA 30 from BASF. Suitable, albeit less preferred compounds of this class are copolymers of acrylic acid or methacrylic acid with vinyl ethers, such as vinyl methyl ethers, vinyl esters, ethylene, propylene, and styrene, in which the proportion of the acid is at least 50 wt. %. It is also possible to use, as water-soluble organic builder substances, terpolymers which contain two unsaturated acids and/or the salts thereof as monomers and vinyl alcohol and/or an esterified vinyl alcohol or a carbohydrate as the third monomer. The first acid monomer or the salt thereof is derived from a monoethylenically unsaturated C₅-C₈ carboxylic acid and preferably from a C₃-C₄ monocarboxylic acid, in particular from (meth)acrylic acid. The second acidic monomer or the salt thereof can be a derivative of a C₄-C₈ dicarboxylic acid, maleic acid being particularly preferred, and/or a derivative of an allylsulfonic acid which is substituted in the 2nd position with an alkyl or aryl group. Such polymers generally have a relative molecular mass between 1,000 g/mol and 200,000 g/mol. Further preferred copolymers are those which have acrolein and acrylic acid/acrylic acid salts or vinyl acetate as monomers. The organic builder substances may, in particular for the preparation of liquid agents, be used in the form of aqueous solutions, preferably in the form of 30 to 50 wt. % aqueous solutions. All of said acids are generally used in the form of their water-soluble salts, in particular their alkali salts.

Organic builder substances of this kind can, if desired, be contained in amounts of up to 40 wt. %, in particular up to 25 wt. %, and preferably from 1 wt. % to 8 wt. %. Amounts close to the stated upper limit are preferably used in pasty or liquid, in particular water-containing, agents according to the invention.

In particular, alkali silicates, alkali carbonates and alkali phosphates, which can be present in the form of their alkaline, neutral, or acidic sodium or potassium salts, can be used as water-soluble inorganic builder materials. Examples thereof are trisodium phosphate, tetrasodium diphosphate, disodium dihydrogen diphosphate, pentasodium triphosphate, sodium hexametaphosphate, oligomeric trisodium phosphate with degrees of oligomerization of 5 to 1000, in particular 5 to 50, and the corresponding potassium salts or mixtures of sodium and potassium salts. In particular crystalline or amorphous alkali aluminosilicates are used as water-insoluble, water-dispersible inorganic builder materials in amounts of up to 50 wt. %, preferably no greater than 40 wt. %, and in liquid agents in particular in amounts of from 1 wt. % to 5 wt. %. Among these, the crystalline sodium aluminosilicates in detergent quality, in particular zeolite A, P, and optionally X, either alone or in mixtures, for example in the form of a co-crystallizate of the zeolites A and X (Vegobond® AX, a commercial product of Condea Augusta S.p.A.), are preferred. Amounts close to the stated upper limit are preferably used in solid, particulate agents. Suitable aluminosilicates have, in particular, no particles having a particle size above 30 μm and preferably consist by at least 80 wt. % of particles having a size below 10 μm. The calcium binding capacity of said aluminosilicates is generally in the range of from 100 to 200 mg CaO per gram.

Suitable substitutes or partial substitutes for the above-mentioned aluminosilicate are crystalline alkali silicates, which can be present alone or in a mixture with amorphous silicates. The alkali silicates that can be used in the agents according to the invention as builders preferably have a molar ratio of alkali oxide to SiO₂ of less than 0.95, in particular of from 1:1.1 to 1:12, and may be present in amorphous or crystalline form. Preferred alkali silicates are sodium silicates, in particular amorphous sodium silicates, having a molar ratio of Na₂O:SiO₂ of from 1:2 to 1:2.8. As crystalline silicates, which may be present alone or in admixture with amorphous silicates, crystalline phyllosilicates of general formula Na₂SiₓO₂ₓ₊₁ y H₂O are preferably used, in which x, known as the modulus, is a number from 1.9 to 22, in particular 1.9 to 4, and y is a number from 0 to 33, and preferred values for x are 2, 3 or 4. Preferred crystalline phyllosilicates are those in which x assumes the values 2 or 3 in the mentioned general formula. In particular, both β- and δ-sodium disilicates (Na₂Si₂O₅ y H₂O) are preferred. Practically water-free crystalline alkali silicates of the above general formula, in which x is a number from 1.9 to 2.1 and which are produced from amorphous alkali silicates, may also be used in agents according to the invention. In another preferred embodiment of agents according to the invention, a crystalline sodium phyllosilicate having a modulus of 2 to 3 is used. Crystalline sodium silicates having a module in the range of from 1.9 to 3.5 are used in a further preferred embodiment of agents according to the invention. Crystalline phyllosilicates are commercially available, e.g., Na-SKS-1 (Na₂Si₂₂O₄₅xH₂O, kenyaite), Na-SKS-2 (Na₂Si₁₄O₂₉xH₂O, magadiite), Na-SKS-3 (Na₂Si₈O₁₇xH₂O) or Na-SKS-4 (Na₂Si₄O₉xH₂O, macatite). Of these, Na-SKS-5 (α-Na₂Si₂O₅), Na-SKS-7 (B-Na₂Si₂O₅, natrosilite), Na-SKS-9 (NaHSi₂O₅3H₂O), Na-SKS-10 (NaHSi₂O₅3H₂O, kanemite), Na-SKS-11 (t-Na₂Si₂O₅) and Na-SKS-13 (NaHSi₂O₅), and in particular Na-SKS-6 (δ-Na₂Si₂O₅) are particularly suitable. In a preferred embodiment of agents according to the invention, a granular compound made of crystalline phyllosilicate and citrate, crystalline phyllosilicate and the above-described (co) polymeric polycarboxylic acid, or alkali silicate and alkali carbonate is used, as it is commercially available under the name Nabion® 15, for example. Builder substances are normally present in amounts of up to 75 wt. %, and in particular of 5 wt. % to 50 wt. %.

Suitable peroxygen compounds for use in detergents include, in particular, organic peroxy acids or peracid salts of organic acids, such as phthalimidopercaproic acid, perbenzoic acid, or salts of diperdodecanoic diacid, hydrogen peroxide and inorganic salts giving off hydrogen peroxide under the washing conditions, which include perborate, percarbonate, persilicate, and/or persulfates such as caroate. If solid peroxygen compounds are intended to be used, these may be used in the form of powders or granules, which may also be coated in a manner known in principle. If an agent according to the invention contains peroxygen compounds, these are present in amounts of preferably up to 50 wt. %, in particular from 5 wt. % to 30 wt. %. The addition of small amounts of known bleaching agent stabilizers such as phosphonates, borates or metaborates, metasilicates, and magnesium salts such as magnesium sulfate may be expedient.

Compounds which, under perhydrolysis conditions, result in aliphatic peroxocarboxylic acids having preferably 1 to 10 C atoms, in particular 2 to 4 C atoms, and/or optionally substituted perbenzoic acid, may be used as bleach activators. Substances that have O acyl and/or N acyl groups of the stated number of C atoms and/or optionally substituted benzoyl groups are suitable. Preferred are polyacylated alkylene diamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoyl succinimide (NOSI), acylated phenolsulfonates, in particular n-nonanoyl- or isononanoyloxybenzenesulfonate (n- or iso-NOBS), carboxylic acid anhydrides, in particular phthalic acid anhydride, acylated polyhydric alcohols, in particular triacetin, ethylene glycol diacetate, 2,5-diacetoxy-2,5-dihydrofuran and enol ester, and acetylated sorbitol and mannitol or the mixtures thereof (SORMAN), acylated sugar derivatives, in particular pentaacetyl glucose (PAG), pentaacetyl fructose, tetraacetyl xylose and octaacetyl lactose, and acetylated, optionally N-alkylated glucamine and gluconolactone, and/or N-acylated lactams, for example N-benzoyl caprolactam. The hydrophilically substituted acyl acetals and the acyl lactams are likewise preferably used. Combinations of conventional bleach activators can also be used. Such bleach activators may, in particular in the presence of the aforementioned hydrogen-peroxide-yielding bleaching agents, be present in the customary quantity range, preferably in amounts of 0.5 wt. % to 10 wt. %, and in particular 1 wt. % to 8 wt. %, based on the total agent, but are preferably entirely absent when percarboxylic acid is used as the sole bleaching agent.

In addition to or instead of the conventional bleach activators, sulfonimines and/or bleach-enhancing transition metal salts or transition metal complexes may also be contained as what are referred to as bleach catalysts.

Enzymes from the class of amylases, proteases, lipases, cutinases, pullulanases, hemicellulases, cellulases, oxidases, laccases and peroxidases, and mixtures thereof, are suitable as enzymes that can be used in the agents. Enzymatic active ingredients obtained from fungi or bacteria, such as Bacillus subtilis, Bacillus licheniformis, Bacillus lentus, Streptomyces griseus, Humicola lanuginosa, Humicola insolens, Pseudomonas pseudoalcaligenes, Pseudomonas cepacia, or Coprinus cinereus are particularly suitable. The enzymes can be adsorbed on carrier substances and/or embedded in coating substances to protect the enzymes from premature inactivation. They are contained in the detergents or cleaning agents according to the invention preferably in amounts of up to 5 wt. %, in particular from 0.2 wt. % to 4 wt. %. If the agent according to the invention contains protease, it preferably has a proteolytic activity in the range of approximately 100 PE/g to approximately 10,000 PE/g, in particular 300 PE/g to 8,000 PE/g. If a plurality of enzymes is to be used in the agent according to the invention, this can be carried out by incorporation of the two or more separate enzymes or enzymes that have been separately manufactured in a known manner, or by two or more enzymes manufactured together in a granulate.

The organic solvents that can be used in the detergents, in particular when the agents are present in liquid or pasty form, include alcohols having 1 to 4 C atoms, in particular methanol, ethanol, isopropanol, and tert-butanol, diols having 2 to 4 C atoms, in particular ethylene glycol and propylene glycol, and mixtures thereof, and the ethers that can be derived from the mentioned compound classes. Water-miscible solvents of this kind are present in the agents according to the invention preferably in amounts of no greater than 30 wt. %, in particular of 6 wt. % to 20 wt. %.

In order to set a desired pH that does not result automatically from mixing the other components, the agents according to the invention may contain acids that are compatible with the system and environment, in particular citric acid, acetic acid, tartaric acid, malic acid, lactic acid, glycolic acid, succinic acid, glutaric acid, and/or adipic acid, but also mineral acids, in particular sulfuric acid, or bases, in particular ammonium or alkali hydroxides. pH regulators of this kind are contained in the agents according to the invention preferably in amounts of no greater than 20 wt. %, in particular of 1.2 wt. % to 17 wt. %.

The function of graying inhibitors is to keep the dirt that is removed from the textile fibers suspended in the liquor. Water-soluble colloids, which are usually organic, are suitable for this purpose, for example starch, sizing material, gelatin, salts of ethercarboxylic acids or ethersulfonic acids of starch or of cellulose, or salts of acidic sulfuric acid esters of cellulose or of starch. Water-soluble polyamides containing acid groups are also suitable for this purpose. Starch derivatives other than those mentioned above may also be used, for example aldehyde starches. Cellulose ethers, such as carboxymethylcellulose (Na salt), methylcellulose, hydroxyalkylcellulose, and mixed ethers, such as methylhydroxyethylcellulose, methylhydroxypropylcellulose, methylcarboxymethylcellulose and mixtures thereof, are preferably used, for example, in amounts of from 0.1 to 5 wt. %, based on the agents.

Washing agents may contain, for example, derivatives of diaminostilbene disulfonic acid or the alkali metal salts thereof as optical brighteners, although they are preferably free of optical brighteners when used as color washing agents. Salts of 4,4′-bis (2-anilino-4-morpholino-1,3,5-triazinyl-6-amino) stilbene-2,2′-disulfonic acid or compounds having a similar structure which, instead of the morpholino group, have a diethanolamino group, a methylamino group, an anilino group or a 2-methoxyethylamino group are suitable, for example. Furthermore, brighteners of the substituted diphenylstyryl type may be present, for example the alkali salts of 4,4′-bis(2-sulfostyryl) diphenyl, 4,4′-bis (4-chloro-3-sulfostyryl) diphenyl, or 4-(4-chlorostyryl)-4′-(2-sulfostyryl) diphenyl. Mixtures of the aforementioned optical brighteners may also be used.

It may be advantageous to add conventional suds suppressors to the agents, in particular in use in mechanical processes. Soaps of natural or synthetic origin having a high proportion of C₁₈-C₂₄ fatty acids are suitable as suds suppressors, for example. Suitable non-surfactant suds suppressors are, for example, organopolysiloxanes and mixtures thereof with microfine, optionally silanated silicic acid and paraffins, waxes, microcrystalline waxes, and mixtures thereof with silanated silicic acid or bis fatty acid alkylenediamides. Mixtures of various suds suppressors are also advantageously used, for example those consisting of silicones, paraffins, or waxes. The foam inhibitors, in particular silicone and/or paraffin-containing foam inhibitors, are preferably bonded to a granular carrier substance that is soluble or dispersible in water. Mixtures of paraffins and bistearylethylenediamide are particularly preferred.

The preparation of solid agents presents no difficulties and can be carried out in a known manner, for example by spray-drying or granulation, in which enzymes and possibly other thermally sensitive ingredients, such as bleaching agents, are optionally added separately later. For the preparation of agents having an increased bulk weight, in particular in the range of from 650 g/l to 950 g/l, a method having an extrusion step is preferred.

To prepare agents in tablet form, which can be single-phase or multiphase, single-color or multi-color, and in particular can be composed of one layer or of multiple layers, in particular of two layers, the procedure is preferably such that all components—optionally one layer each—are mixed with one another in a mixer, and the mixture is compressed using conventional tablet presses, such as eccentric presses or rotary presses, using pressures in the range of approximately 50 to 100 kN, preferably 60 to 70 kN. In the case of multilayer tablets in particular, it can be advantageous if at least one layer is pre-pressed. This is preferably carried out at pressures of between 5 and 20 kN, in particular at 10 to 15 kN. This readily yields break-resistant tablets that nonetheless dissolve sufficiently quickly under usage conditions, normally with breaking and flexural strengths of 100 to 200 N, but preferably above 150 N. A tablet thus produced preferably has a weight of 10 g to 50 g, and in particular of 15 g to 40 g. The tablets can have any physical shape, and they can be round, oval, or angular, wherein intermediate shapes are also possible. Corners and edges are advantageously rounded. Round tablets preferably have a diameter of 30 mm to 40 mm. In particular, the size of angular or cuboid tablets, which are predominantly introduced via the dosing device of the washing machine, is dependent on the geometry and the volume of this dosing device. By way of example, preferred embodiments have a base area of (20 to 30 mm) x (34 to 40 mm), and in particular of 26×36 mm or of 24×38 mm.

Liquid or pasty agents in the form of solutions containing conventional solvents are usually prepared by simple mixing of the ingredients, which can be put into an automatic mixer in bulk or as a solution.

### EXAMPLES

### Example 1: preparation of a 2-methylene-1,3-dioxepane-vinylpyrrolidone copolymer (P1)

A solution of 2-methylene-1,3-dioxepane (MDO; 1 eq, 8 mmol) and azo-bis-(isobutylonitrile) (AIBN; 1 mol %, 0.8 mmol) in 2 ml of dimethylformamide (DMF) was degassed by means of a 3-fold freeze-vacuum-thaw cycle, kept under argon and heated to 70° C. Via a septum, vinylpyrrolidone (VP; 9 eq, 72 mmol) dissolved in 17 ml DMF, which had been degassed in the same way, was added by means of a syringe pump (4.9 ml h⁻¹). After a reaction time of 5 hours, the reaction mixture was poured into diethyl ether. The precipitated polymer was separated off, dissolved in chloroform, again precipitated by addition of pentane, separated off and dried at 60° C. for 48 h under reduced pressure. 4.6 g of copolymer P1 were obtained.
Mₙ: 13000 g/mol, M_{w}: 30000 g/mol, D: 2.37

MDO was present in the copolymer P1 at a proportion of 8%, determined by means of ¹H-NMR spectroscopy.

### Example 2: preparation of a 2-methylene-1,3-dioxepane-vinylpyrrolidone copolymer (P2)

MDO (1 eq, 7 mmol) and AIBN (1 mol %, 0.7) were dissolved in 3.4 ml of DMF and degassed by means of a 3-fold freeze-thaw cycle, kept under argon and heated to 70° C. Via a septum, VP (8 eq, 56 mmol) dissolved in 13 ml DMF, which had been degassed in the same way, was added by means of a syringe pump (2.4 ml h 1). After a reaction time of 8 hours, the reaction mixture was poured into diethyl ether. The precipitated polymer was separated off, dissolved in chloroform, again precipitated by addition of pentane, separated off and dried at 60° C. for 48 h under reduced pressure. 4.1 g of copolymer P2 were obtained.
Mₙ: 10000 g/mol, M_{w}: 30000 g/mol, D: 2.08

MDO was present in the copolymer P2 at a proportion of 10%, determined by means of ¹H-NMR spectroscopy.

### Example 3: preparation of a 2-methylene-1,3-dioxepane-vinylpyrrolidone copolymer (P3)

MDO (4.5 eq, 36 mmol) and AIBN (1 mol %, 0.8 mmol) were dissolved in 8.7 ml of DMF and degassed by means of a 3-fold freeze-vacuum-thaw cycle, kept under argon and heated to 70° C. Via a septum, VP (5.5 eq, 44 mmol) dissolved in 10.3 ml DMF, which had been degassed in the same way, was added by means of a syringe pump (0.83 ml h 1). After a reaction time of 18 hours, the reaction mixture was poured into diethyl ether. The precipitated polymer was separated off, dissolved in chloroform, again precipitated by addition of pentane, separated off and dried at 60° C. for 48 h under reduced pressure. 2.2 g of copolymer P3 were obtained.
Mₙ: 3100 g/mol, M_{w}: 4600 g/mol, D: 1.47

MDO was present in the copolymer P3 at a proportion of 33%, determined by means of ¹H-NMR spectroscopy.

### Example 4: preparation of a 2-methylene-1,3-dioxepane-vinylpyrrolidone-vinylimidazole copolymer (P4)

MDO (3 eq, 24 mmol) and AIBN (1 mol %, 0.8 mmol) were dissolved in 5.8 ml of DMF and degassed by means of a 3-fold freeze-vacuum-thaw cycle, kept under argon and heated to 70° C. Via a septum, VP (3.5 eq, 28 mmol) und vinylimidazole (VI; 3.5 eq, 28 mmol) dissolved in 12.3 ml DMF, which had been degassed in the same way, were added by means of a syringe pump (1.1 ml h⁻¹). After a reaction time of 2 hours, the reaction mixture was poured into diethyl ether. The precipitated polymer was separated off, dissolved in chloroform, again precipitated by addition of pentane, separated off and dried at 60° C. for 48 h under reduced pressure. 4.5 g of copolymer P4 were obtained.
Mₙ: 12000 g/mol, M_{w}: 18000 g/mol, D: 1.47

MDO was 15% and VP and VI were each 42.5% in copolymer P4, determined by means of ¹H NMR spectroscopy.

### Example 5: preparation of a 2-methylene-1,3-dioxepane-vinylimidazole copolymer (P5)

MDO (1 eq, 6.6 mmol) and AIBN (1 mol %, 0.33 mmol) were dissolved in 0.65 ml of DMF and degassed by means of a 3-fold freeze-vacuum-thaw cycle, kept under argon and heated to 70° C. Via a septum, VI (4 eq, 26.4 mmol) dissolved in 2.1 ml DMF, which had been degassed in the same way, was added by means of a syringe pump (0.4 ml h 1). After a reaction time of 2 hours, the reaction mixture was poured into diethyl ether. The precipitated polymer was separated off, dissolved in chloroform, again precipitated by addition of pentane, separated off and dried at 60° C. for 48 h under reduced pressure. 2.8 g of copolymer P5 were obtained.
Mₙ: 7500 g/mol, M_{w}: 13000 g/mol, D: 1.78

MDO was present in the copolymer P5 at a proportion of 13%, determined by means of 1H-NM spectroscopy.

### Example 6: Dye Inhibition Inhibition

The color releasers (colored textiles that release dye easily) indicated in the following table were washed at 60° C. for 30 minutes in the presence of white acceptor tissues also indicated in the table (6 cm×16 cm). Thereafter, the coloration of the cotton textile was determined by spectrophotometry and evaluated according to ISO 105 A04 (SSR grades on a scale of 1 to 5; 1=strong coloration, 5=no coloration). Washing liquors were used with, in each case, a dye-transfer-inhibitor-free water-containing liquid detergent (F1 or F2; concentration 3.5 g/l) or with the same amounts of an otherwise identically composed agent to which one of polymers P1 to P5 prepared in Examples 1 to 5 had been added while reducing the amount of water. The following SSR grades were obtained (mean value from 2-fold determination in each case):

TABLE 1
Results of the dye inhibition inhibition

| Acceptor | Color releaser | F1 | F1 + P1 | F1 + P2 | F1 + P3 | F1 + P4 | F2 | F2 + P5 |
|---|---|---|---|---|---|---|---|---|
| Cotton | Direct Black 22 | 3.7 | 4.2 | 4.2 | n/a | n/a | n/a | n/a |
| Cotton | Direct Orange 39 | 2.0 | 3.0 | 3.0 | n.a. | 2.7 | 2.0 | 2.7 |
| Cotton | Direct Red 83:1, | 2.9 | 3.6 | 3.6 | 3.5 | 4.9 | 3.0 | 4.9 |
| | EMPA | | | | | | | |
| Polyamide | Direct Black 22 | 3.5 | 4.1 | 4.2 | n/a | n/a | 4.1 | 4.6 |
| Polyamide | Direct Orange 39 | 2.4 | 4.0 | 4.0 | 3.3 | 3.8 | 2.5 | 4.1 |

n/a = Determination not executed

It can be seen that, in comparison to the detergent not comprising the addition of the copolymers essential to the invention, the white textiles became colored to a lesser degree when washed with copolymer additive.

What is claimed is:

1. A method for washing white or colored textiles comprising a step of contacting the textiles with a surfactant-containing aqueous liquor wherein the surfactant-containing aqueous liquor contains a copolymer obtained by radical polymerization of cyclic ketene acetals with vinylimidazole monomers and/or vinylpyrrolidone monomers.

2. The method according to claim 1, wherein 0.0003 g/l to 0.16 g/l of the copolymer is used in the aqueous liquor.

3. The method according to claim 1, wherein 0.0015 g/l to 0.015 g/l of the copolymer is used in the aqueous liquor.

4. A detergent composition comprising a washing agent containing surfactant and a dye transfer inhibitor in a dye transfer-inhibiting amount, wherein the dye transfer inhibitor comprises a copolymer obtained by radical polymerization of cyclic ketene acetals with acrylic and/or vinyl monomers.

5. The detergent composition according to claim 4, wherein the copolymer is in amounts of from 0.01 wt. % to 5 wt. %.

6. The detergent composition according to claim 4, wherein the dye transfer inhibitor further comprises polymers selected from the group consisting of vinylpyrrolidone, vinylimidazole, vinylpyridine N-oxide, and the copolymers thereof.

7. The detergent composition according to claim 4, wherein the copolymer is composed of 5 mol % to 50 mol % of at least one cyclic ketene acetal monomer, and 50 mol % to 95 mol % vinyl monomers, or mixtures thereof with acrylic monomers, wherein the vinyl monomers consist in part, of vinylimidazole monomers and/or vinylpyrrolidone monomers.

8. The detergent composition according to claim 4, wherein the ketene acetal is selected from a group consisting of 4,5,-di-C₁₋₁₂-alkyl-2-methylene-1,3-dioxolane, 4-C₁₋₁₂-alkyl-2-methylene-1,3-dioxolane, 5-C₁₋₁₂-alkyl-2-methylene-1,3-dioxepane, 5,6-di-C₁₋₁₂-alkyl-2-methylene-1,3-dioxepane, 4-C₁₋₁₂-alkyl-2-methylene-1,3-dioxane, 4,6-di-C₁₋₁₂-alkyl-2-methylene-1,3-dioxolane and 5,6-benzo-2-methylene-1,3-dioxepane, 4-phenyl-2-methylene-1,3-dioxolane, 4,5-di-phenyl-2-methylene-1,3-dioxolane, 4-phenyl-2-methylene-1,3-dioxane, 4,6-di-phenyl-2-methylene-1,3-dioxolane, 4-phenyl-2-methylene-1,3-dioxepane, 4,7-di-phenyl-2-methylene-1,3-dioxepane and mixtures thereof.

9. The detergent composition according to claim 4, wherein the comonomer polymerizable with the ketene acetal is selected from the group consisting of vinylimidazole, vinylpyrrolidone, mixtures thereof, and mixtures of vinylimidazole and/or vinylpyrrolidone with acrylic acid esters, acrylic acid amides, methacrylic acid esters, methacrylic acid amides, and mixtures thereof.
